(19) United States
(12) Patent Application Publication
(10) Pub. No.: US 2017/0128952 A1
(43) Pub. Date: May 11, 2017

(54) SORTING DEVICE AND SORTING METHOD

(71) Applicant: NATIONAL INSTITUTE OF ADVANCED INDUSTRIAL SCIENCE AND TECHNOLOGY, Tokyo (JP)

(72) Inventors: Tatsuya OKI, Ibaraki (JP); Tomohiro NOGUCHI, Ibaraki (JP); Taeko HAZUMI, Ibaraki (JP)

(21) Appl. No.: 15/317,505

(22) PCT Filed: Jun. 9, 2015
(86) PCT No.: PCT/JP2015/066560

§ 371 Date: Dec. 9, 2016

(30) Foreign Application Priority Data
Jun. 16, 2014 (JP) 2014-123251

(51) Int. Cl. B03C 1/025

(52) U.S. Cl. CPC B03C 1/025; B03C 2201/18

(57) ABSTRACT

The present invention provides a sorting device and a sorting method for sorting a magnetically attractable substance and a non-magnetically attractable substance from a sorting target using a high gradient magnetic separator.

### TECHNICAL FIELD

The present invention relates to a sorting device and a sorting method for sorting a magnetically attractable substance and a non-magnetically attractable substance from a sorting target using a high gradient magnetic separator.

### BACKGROUND ART

There has long been known a magnetic separation method of placing ferromagnet thin lines (matrix) under a uniform magnetic field and generating a high magnetization gradient near the ferromagnet thin lines. The ferromagnet thin lines can be utilized as a magnetic filter, making it possible to magnetically separate a magnetically attractable substance, which is magnetically attracted to the ferromagnet thin lines, and a non-magnetically attractable substance, which is not magnetically attracted to the ferromagnet thin lines, in a sorting target fluid introduced into a flow path where the ferromagnet thin lines are disposed.

The magnetic separator based on the principle of the magnetic separation method has developed as a high gradient magnetic separator (HGMS; High Gradient Magnetic Separator) and even today, the high gradient magnetic separator has newly been being developed. Specifically, the high gradient magnetic separator has a main object to increase separation accuracy and separation efficiency between the magnetically attractable substance and the non-magnetically attractable substance. For example, one proposed method is blowing pressurized gas in a magnetically attractable substance recovering step in order for particles adsorbed onto the magnetic filter to be detached more easily (see PTL 1).

However, the sorting devices utilizing the high gradient magnetic separator that have been proposed so far do not achieve a fundamental improvement in separation accuracy and separation efficiency. Referring to FIGS. 1A to 1C, this situation will be described taking as an example a Jones-type wet high gradient sorting device which is typical as the sorting device. FIGS. 1A to 1C are depictive diagrams depicting a conventional sorting device using a Jones-type wet high gradient magnetic separator.

As illustrated in FIG. 1A, a sorting device 100 includes as main members, a high gradient magnetic separating section 50 including an electromagnet 50a, a magnetic filter 50b, and a magnetic separation flow path 50c, a sorting target fluid introducing flow path 101b coupled to one end of the magnetic separation flow path 50c via an on-off valve 101a and capable of introducing a sorting target fluid into the magnetic separation flow path 50c, a non-magnetically attractable substance discharging flow path 103b coupled to the other end of the magnetic separation flow path 50c via an on-off valve 103a and capable of discharging from the magnetic separation flow path 50c, the sorting target fluid from which any magnetically attractable substance has been magnetically attracted to the magnetic filter 50b, a carrier fluid introducing flow path 104b coupled to the other end of the magnetic separation flow path 50c via an on-off valve 104a and capable of introducing into the magnetic separation flow path 50c, a carrier fluid (e.g., water) capable of carrying the magnetically attractable substance detached from the magnetic filter 50b, and a magnetically attractable substance discharging flow path 105b coupled to the one end of the magnetic separation flow path 50c via an on-off valve 105a and capable of discharging from the magnetic separation flow path 50c, the carrier fluid carrying the magnetically attractable substance detached from the magnetic filter 50b.

The sorting device 100 is configured to sort the magnetically attractable substance and the non-magnetically attractable substance by separating the magnetically attractable substance and the non-magnetically attractable substance from the sorting target fluid.

First, as illustrated by arrows in FIG. 1A, only the on-off valve 101a of the on-off valves on the one end of the magnetic separation flow path 50c is opened to the magnetic separation flow path 50c in a state that the electromagnet 50a is excited, to introduce into the magnetic separation flow path 50c, the sorting target fluid introduced into the sorting target fluid introducing flow path 101b by means of a pump 101d from a storing section 101c storing the sorting target fluid and have the magnetically attractable substance magnetically attracted to the magnetic filter 50b, and only the on-off valve 103a of the on-off valves on the other end of the magnetic separation flow path 50c is opened to discharge into the non-magnetically attractable substance discharging flow path 103b, the sorting target fluid from which the magnetically attractable substance has been magnetically attracted and recover the sorting target fluid into a non-magnetically attractable substance recovering section 103c (a non-magnetically attractable substance sorting step).

Next, as illustrated by arrows in FIG. 1C, only the on-off valve 104a of the on-off valves on the other end of the magnetic separation flow path 50c is opened to the magnetic separation flow path 50c in a state that the electromagnet 50a is released from excitation, to introduce the carrier fluid into the magnetic separation flow path 50c from the carrier fluid introducing flow path 104b, and only the on-off valve 105a of the on-off valves on the one end of the magnetic separation flow path 50c is opened to have the carrier fluid carry the magnetically attractable substance detached from the magnetic filter 50c to discharge the magnetically attractable substance from the magnetic separation flow path 50c into the magnetically attractable substance discharging flow path 105b and recover the magnetically attractable substance into a magnetically attractable substance recovering section 105c (a magnetically attractable substance sorting step).

In the sorting device 100, by operating each of the on-off valves to repeatedly perform the non-magnetically attractable substance sorting step and the magnetically attractable substance sorting step while switching them based on the magnetic attraction capability of the magnetic filter 50, it is possible to sort the magnetically attractable substance and the non-magnetically attractable substance by separating the magnetically attractable substance and the non-magnetically attractable substance from the sorting target fluid.

In the sorting device 100, however, upon switching between the non-magnetically attractable substance sorting step and the magnetically attractable substance sorting step, the sorting target fluid from which the magnetically attractable substance and the non-magnetically attractable substance have not yet been separated is retained in the magnetic separation flow path 50c, raising a problem with reduction in separation accuracy. Therefore, in order to perform separation with high accuracy, it is necessary to circulate substances that have once undergone sorting, as the sorting target fluid to repeat a similar sorting operation, resulting in reduction in separation efficiency.

Specifically, as illustrated in FIG. 1B, at the time of operation of the non-magnetically attractable substance sorting step, the non-sorted sorting target fluid not having undergone sorting by the magnetic filter 50b is retained on the one end of the magnetic separation flow path 50c. Also, the sorting target fluid from which the magnetically attractable substance has been attracted and which is to be discharged into the non-magnetically attractable substance discharging flow path 103b is retained on the other end of the magnetic separation flow path 50c. In this state, when the non-magnetically attractable substance sorting step is switched to the magnetically attractable substance sorting step by operating each of the on-off valves and the electromagnet 50a, the non-sorted sorting target fluid retained in the magnetic separation flow path 50c, and the sorting target fluid from which the magnetically attractable substance has been attracted and which is to be discharged into the non-magnetically attractable substance discharging flow path 103b are discharged to the magnetically attractable substance discharging flow path 105b. As a result, there is a problem with unintentional inclusion of the non-magnetically attractable substance in the magnetically attractable substance recovering section 105c.

### CITATION LIST

### Patent Literature

PTL 1: Japanese Patent Application Laid-Open (JP-A) No. 05-123510

### SUMMARY OF INVENTION

### Technical Problem

The present invention aims to overcome the various conventional problems described above and achieve the object described below. That is, an object of the present invention is to provide a sorting device and a sorting method for sorting a magnetically attractable substance and a non-magnetically attractable substance from a sorting target using a high gradient magnetic separator with high accuracy and high efficiency.

### Solution to Problem

Solutions to the problems described above are as follows.

<1> A sorting device, which is capable of sorting a magnetically attractable substance and a non-magnetically attractable substance by separating the magnetically attractable substance and the non-magnetically attractable substance from a sorting target fluid which is a mixture of the magnetically attractable substance and the non-magnetically attractable substance, the sorting device including:

a high gradient magnetic separating section, which includes an electromagnet, a magnetic filter capable of attracting or detaching the magnetically attractable substance with a magnetic field generated by the electromagnet, and a magnetic separation flow path with the electromagnet disposed outside and the magnetic filter disposed inside;

a sorting target fluid introducing flow path, which is coupled to one end of the magnetic separation flow path via a first on-off valve and is capable of introducing the sorting target fluid into the magnetic separation flow path;

a first carrier fluid introducing flow path, which is coupled to the one end of the magnetic separation flow path via a second on-off valve and is capable of introducing into the magnetic separation flow path, a first carrier fluid capable of carrying the sorting target fluid;

a non-magnetically attractable substance discharging flow path, which is coupled to other end of the magnetic separation flow path via a third on-off valve and is capable of discharging from the magnetic separation flow path, the sorting target fluid from which the magnetically attractable substance has been magnetically attracted to the magnetic filter, and the first carrier fluid;

a second carrier fluid introducing flow path, which is coupled to the other end of the magnetic separation flow path via a fourth on-off valve and is capable of introducing into the magnetic separation flow path, a second carrier fluid capable of carrying the magnetically attractable substance detached from the magnetic filter; and a magnetically attractable substance discharging flow path, which is coupled to the one end of the magnetic separation flow path via a fifth on-off valve and is capable of discharging from the magnetic separation flow path, the second carrier fluid that carries the magnetically attractable substance detached from the magnetic filter.

<2> The sorting device according to <1>, further including a residual substance discharging flow path, which is coupled to the other end of the magnetic separation flow path via a sixth on-off valve and is capable of discharging from the magnetic separation flow path, the first carrier fluid that carries a residual substance remaining in the magnetic filter.
<3> A sorting method for sorting a magnetically attractable substance and a non-magnetically attractable substance by separating the magnetically attractable substance and the non-magnetically attractable substance with the sorting device according to <1> or <2>, the sorting method including:

a non-magnetically attractable substance sorting step in which only the first on-off valve of the on-off valves on the one end of the magnetic separation flow path is opened to the magnetic separation flow path in a state that the electromagnet is excited, to introduce the sorting target fluid from the sorting target fluid introducing flow path and have the magnetically attractable substance magnetically attracted to the magnetic filter, and only the third on-off valve of the on-off valves on the other end of the magnetic separation flow path is opened to discharge into the non-magnetically attractable substance discharging flow path, the sorting target fluid from which the magnetically attractable substance has been magnetically attracted;

a residual non-magnetically attractable substance sorting step in which after the non-magnetically attractable substance sorting step, only the second on-off valve of the on-off valves on the one end of the magnetic separation flow path is opened to the magnetic separation flow path in a state that the electromagnet is excited, to introduce a first carrier fluid from a first carrier fluid introducing flow path, and only the third on-off valve of the on-off valves on the other end of the magnetic separation flow path is opened to have the first carrier fluid carry the sorting target fluid in a state that the magnetically attractable substance remaining in the magnetic separation flow path has been magnetically attracted to the magnetic filter, to discharge the sorting target fluid into the non-magnetically attractable substance discharging flow path from the magnetic separation flow path; and

a magnetically attractable substance sorting step in which after the residual non-magnetically attractable substance sorting step, only the fourth on-off valve of the on-off valves on the other end of the magnetic separation flow path is opened to the magnetic separation flow path in a state that the electromagnet is released from excitation, to introduce the second carrier fluid from a second carrier fluid introducing flow path, and only the fifth on-off valve of the on-off valves on the one end of the magnetic separation flow path is opened to have the second carrier fluid carry the magnetically attractable substance detached from the magnetic filter to discharge the magnetically attractable substance into the magnetically attractable substance discharging flow path from the magnetic separation flow path.

<4> The sorting method according to <3>,

wherein the non-magnetically attractable substance sorting step, the residual non-magnetically attractable substance sorting step, and the magnetically attractable substance sorting step are repeatedly performed as a series of steps.

<5> The sorting method according to <3> or <4>, further including a residual substance discharging step, which is provided between the residual non-magnetically attractable substance sorting step and the magnetically attractable substance sorting step and in which only the second on-off valve of the on-off valves on the one end of the magnetic separation flow path is opened to the magnetic separation flow path in a state that the electromagnet is excited, to introduce the first carrier fluid from the first carrier fluid introducing flow path, and only the sixth on-off valve of the on-off valves on the other end of the magnetic separation flow path is opened to have the first carrier fluid carry a residual substance remaining in the magnetic filter, to discharge the residual substance into the residual substance discharging flow path from the magnetic separation flow path.

### Advantageous Effects of Invention

According to the present invention, it is possible to overcome the various problems of the conventional techniques and provide a sorting device and a sorting method for sorting a magnetically attractable substance and a non-magnetically attractable substance from a sorting target using a high gradient magnetic separator with high accuracy and high efficiency.

### BRIEF DESCRIPTION OF DRAWINGS

FIG. 1A is a depictive diagram (1) depicting a conventional sorting device using a Jones-type wet high gradient magnetic separator.

FIG. 1B is a depictive diagram (2) depicting a conventional sorting device using a Jones-type wet high gradient magnetic separator.

FIG. 1C is a depictive diagram (3) depicting a conventional sorting device using a Jones-type wet high gradient magnetic separator.

FIG. 2A is a depictive diagram (1) depicting a sorting device according to one embodiment of the present invention.

FIG. 2B is a depictive diagram (2) depicting a sorting device according to one embodiment of the present invention.

FIG. 2C is a depictive diagram (3) depicting a sorting device according to one embodiment of the present invention.

FIG. 2D is a depictive diagram (4) depicting a sorting device according to one embodiment of the present invention.

FIG. 2E is a depictive diagram (5) depicting a sorting device according to one embodiment of the present invention.

### DESCRIPTION OF EMBODIMENTS

(Sorting Device)

A sorting device of the present invention is a sorting device capable of sorting a magnetically attractable substance and a non-magnetically attractable substance by separating the magnetically attractable substance and the non-magnetically attractable substance from a sorting target fluid which is a mixture of the magnetically attractable substance and the non-magnetically attractable substance, the sorting device including a high gradient magnetic separating section, a sorting target fluid introducing flow path, a first carrier fluid introducing flow path, a non-magnetically attractable substance discharging flow path, a second carrier fluid introducing flow path, and a magnetically attractable substance discharging flow path, and if necessary, further includes optional members such as a residual substance discharging flow path.

So long as the sorting target fluid contains the magnetically attractable substance, the sorting target fluid is not particularly limited and can be applied to sorting by the sorting device. Examples of the sorting target fluid include fluidic substances containing solid materials containing the magnetically attractable substance, such as recycle samples, fluorescent substances, fluorescent lamp samples, samples produced from mines, and wrapping samples for foods and pharmaceuticals. Examples of the fluidic substances include slurry obtained by dispersing the solid materials in suspension liquids.

The magnetically attractable substance refers to a magnetically attractable substance that is set as being magnetically attractable by the magnetic filter described below. The target of this setting may include only a magnetically attractable substance having a high magnetic susceptibility, or may also include a magnetically attractable substance having a low magnetic susceptibility. That is, is it possible to set variably whether a substance is magnetically attractable by the magnetic filter or not, based on the level of the density of a magnetic flux generated by the electromagnet and the size of a magnetic gradient formed by the magnetic filter. Here, a magnetically attractable substance set as being magnetically attractable to the magnetic filter is referred to as the magnetically attractable substance, and any other substance than such a magnetically attractable substance is referred to as the non-magnetically attractable substance.

<High Gradient Magnetic Separating Section>

The high gradient magnetic separating section includes an electromagnet, a magnetic filter capable of attracting or detaching the magnetically attractable substance with a magnetic field generated by the electromagnet, and a magnetic separation flow path with the electromagnet disposed outside and the magnetic filter disposed inside.

The electromagnet is not particularly limited and may be appropriately selected depending on the intended purpose. Electromagnets used in known high gradient magnetic separators can widely be used.

The magnetic filter is not particularly limited and magnetic filters used in known high gradient magnetic separators can widely be used.

A material constituting the magnetic separation flow path is not particularly limited and may be appropriately selected depending on the intended purpose. Known pipes made of stainless steel and the like can widely be used.

<Sorting Target Fluid Introducing Flow Path>

The sorting target fluid introducing flow path is coupled to one end of the magnetic separation flow path via a first on-off valve and is capable of introducing the sorting target fluid into the magnetic separation flow path.

The first on-off valve is not particularly limited and may be appropriately selected depending on the intended purpose so long as the first on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the sorting target fluid introducing flow path is not particularly limited and may be appropriately selected depending on the intended purpose. Known pipes made of stainless steel and the like can widely be used.

Attachments of the sorting target fluid introducing flow path are not particularly limited. A pump configured to introduce the sorting target fluid into this flow path or a storing section storing the sorting target fluid may be coupled to the sorting target fluid introducing flow path.

<First Carrier Fluid Introducing Flow Path>

The first carrier fluid introducing flow path is coupled to the one end of the magnetic separation flow path via a second on-off valve and is capable of introducing into the magnetic separation flow path, a first carrier fluid capable of carrying the sorting target fluid.

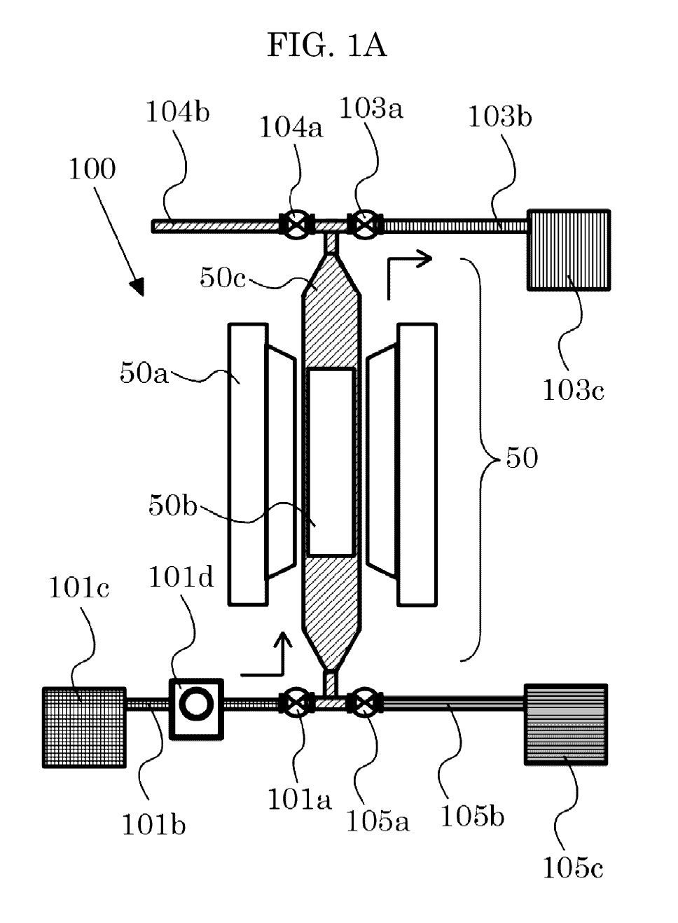

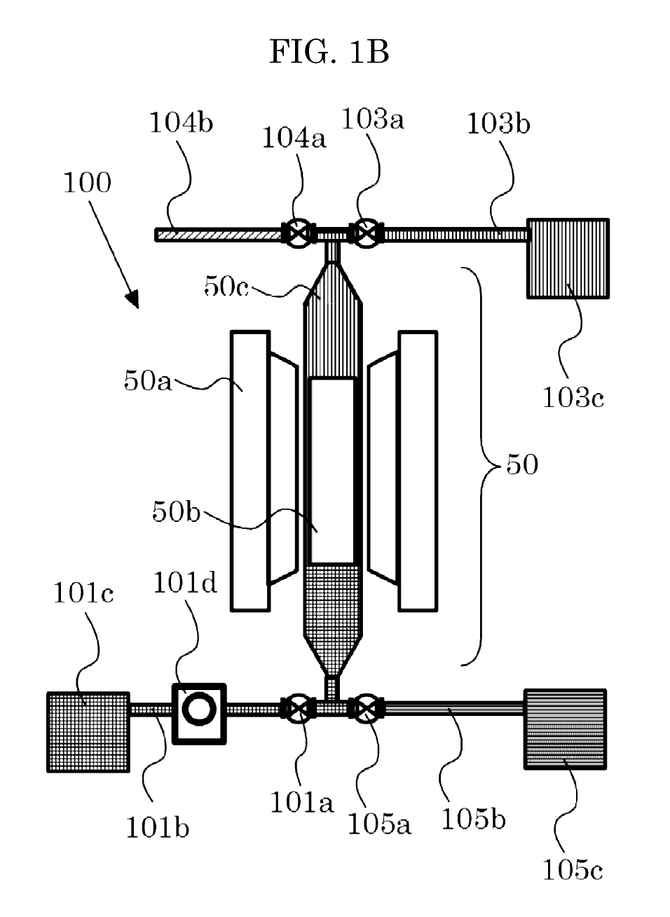

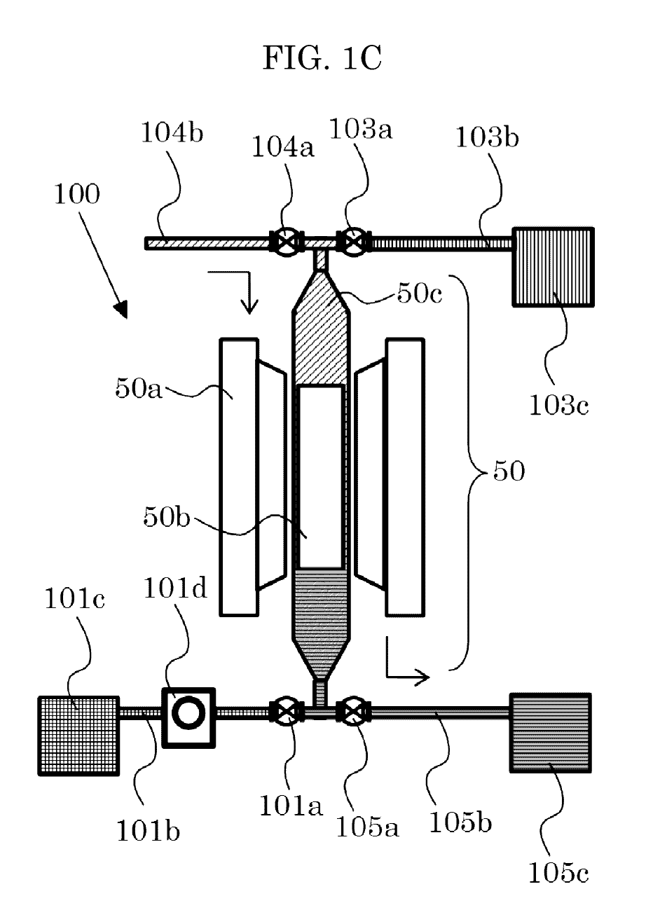

In the sorting device according to the present invention, this first carrier fluid introducing flow path is disposed, and after the operation of the non-magnetically attractable substance sorting step, the sorting target fluid retained in the magnetic separation flow path is carried by the first carrier fluid to the outside of the magnetic separation flow path. This makes it possible to overcome the problem described with reference to FIG. 1B that upon switching the non-magnetically attractable substance sorting step to the magnetically attractable substance sorting step in the conventional sorting device, the non-sorted sorting target fluid and the like retained in the magnetic separation flow path is discharged to the magnetically attractable substance discharging flow path.

The first carrier fluid is not particularly limited so long as the first carrier fluid is a fluid capable of carrying the sorting target fluid. Examples of the first carrier fluid include water. When the residual substance discharging flow path described below is disposed, various rinse liquids for washing (liquids to which known dispersing agents have been added) can be selected and used depending on the kind of the residual substance in terms of effectively washing away the residual substance remaining in the magnetic filter.

Similar to the first on-off valve, the second on-off valve is not particularly limited and may be appropriately selected depending on the intended purpose so long as the second on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the first carrier fluid introducing flow path is not particularly limited and may be appropriately selected depending on the intended purpose. Known pipes made of stainless steel and the like can widely be used.

Attachments of the first carrier fluid introducing flow path are not particularly limited. A pump configured to introduce the first carrier fluid into this flow path or a storing section storing the first carrier fluid may be coupled to the first carrier fluid introducing flow path. When water is used as the first carrier fluid, the first carrier fluid introducing flow path may be coupled to a water pipe. When water serving as the first carrier fluid and the rinse liquid other than water are used in combination, on-off valves can be separately disposed to selectively introduce them into the first carrier fluid introducing flow path.

<Non-Magnetically Attractable Substance Discharging Flow Path>

The non-magnetically attractable substance discharging flow path is coupled to the other end of the magnetic separation flow path via a third on-off valve and is capable of discharging from the magnetic separation flow path, the sorting target fluid from which the magnetically attractable substance has been magnetically attracted to the magnetic filter, and the first carrier fluid.

Similar to the first on-off valve, the third on-off valve is not particularly limited and may be appropriately selected depending on the intended purpose so long as the third on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the non-magnetically attractable substance discharging flow path is not particularly limited and may be appropriately selected depending on the intended purpose. Known pipes made of stainless steel and the like can widely be used.

Attachments of the non-magnetically attractable substance discharging flow path are not particularly limited. Examples of the attachments include a non-magnetically attractable substance recovering section configured to recover the non-magnetically attractable substance. The non-magnetically attractable substance recovering section may be, for example, a common recovering container, or may be such a recovering container equipped with a filtration device configured to filter off the magnetically attractable substance that could not completely sorted by the magnetic filter. When the recovering container is disposed, the recovered substance may be introduced again into the sorting target fluid introducing flow path in order to sort the magnetically attractable substance that could not completely sorted by the magnetic filter.

<Second Carrier Fluid Introducing Flow Path>

The second carrier fluid introducing flow path is coupled to the other end of the magnetic separation flow path via a fourth on-off valve and is capable of introducing into the magnetic separation flow path, a second carrier fluid capable of carrying the magnetically attractable substance detached from the magnetic filter.

The second carrier fluid is not particularly limited so long as the second carrier fluid is a fluid capable of carrying the magnetically attractable substance. Examples of the second carrier fluid include water.

Similar to the first on-off valve, the fourth on-off valve is not particularly limited and may be appropriately selected depending on the intended purpose so long as the fourth on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the second carrier fluid introducing flow path is not particularly limited and may be appropriately selected depending on the intended purpose. Known pipes made of stainless steel and the like can widely be used.

Attachments of the second carrier fluid introducing flow path are not particularly limited. A pump configured to introduce the second carrier fluid into this flow path or a storing section storing the second carrier fluid may be coupled to the second carrier fluid introducing flow path. When water is used as the second carrier fluid, the second carrier fluid introducing flow path may be coupled to a water pipe.

<Magnetically Attractable Substance Discharging Flow Path>

The magnetically attractable substance discharging flow path is coupled to the one end of the magnetic separation flow path via a fifth on-off valve and is capable of discharging from the magnetic separation flow path, the second carrier fluid that carries the magnetically attractable substance detached from the magnetic filter.

Similar to the first on-off valve, the fifth on-off valve is not particularly limited and may be appropriately selected depending on the intended purpose so long as the fourth on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the magnetically attractable substance discharging flow path is not particularly limited and may be appropriately selected depending on the intended purpose. Known pipes made of stainless steel and the like can widely be used.

Attachments of the magnetically attractable substance discharging flow path are not particularly limited. Examples of the attachments include a magnetically attractable substance recovering section configured to recover the magnetically attractable substance. The magnetically attractable substance recovering section may be, for example, a common recovering container, or may be such a recovering container equipped with a filtration device configured to filter off the second carrier fluid and the magnetically attractable substance.

<Residual Substance Discharging Flow Path>

The residual substance discharging flow path is coupled to the other end of the magnetic separation flow path via a sixth on-off valve and is capable of discharging from the magnetic separation flow path, the first carrier fluid that carries the residual substance remaining in the magnetic filter.

In the sorting device according to the present invention, the first carrier fluid introducing flow path is disposed independently of the second carrier fluid introducing flow path, which makes it possible to introduce the rinse liquid as the first carrier fluid into the magnetic separation flow path to wash away the residual substance remaining in the magnetic filter (e.g., the magnetically attractable substance and suspended particles contained in the sorting target fluid) from the magnetic filter and discharge the residual substance from the magnetic separation flow path.

Similar to the first on-off valve, the sixth on-off valve is not particularly limited and may be appropriately selected depending on the intended purpose so long as the sixth on-off valve is controllable to be open or closed independently of other on-off valves. It is possible to use a known on-off valve physically independent of other on-off valves (a 2-way valve) or a known 3-way valve or 4-way valve integrally formed with other on-off valves.

Similar to the magnetic separation flow path, a material constituting the residual substance discharging flow path is not particularly limited and may be appropriately selected depending on the intended purpose. Known pipes made of stainless steel and the like can widely be used.

Attachments of the residual substance discharging flow path are not particularly limited. Examples of the attachments include a residual substance recovering section configured to recover the residual substance. The residual substance recovering section may be, for example, a common recovering container, or may be such a recovering container equipped with a filtration device configured to filter off the magnetically attractable substance, the suspended particles, and the like which have been washed away from the magnetic filter. The recovered substance recovered in the residual substance recovering section may again be circulated in and introduced into the sorting target fluid introducing flow path.

(Sorting Method)

A sorting method according to the present invention is a sorting method for sorting a magnetically attractable substance and a non-magnetically attractable substance by separating the magnetically attractable substance and the non-magnetically attractable substance with the sorting device of the present invention, the sorting method including a non-magnetically attractable substance sorting step, a residual non-magnetically attractable substance sorting step, and a magnetically attractable substance sorting step, and if necessary, further includes optional steps such as a residual substance discharging step. Explanation of the sorting device used for the operation of each of the steps will be omitted because it overlaps with the explanation in the sorting device.

<Non-Magnetically Attractable Substance Sorting Step>

The non-magnetically attractable substance sorting step is a step in which only the first on-off valve of the on-off valves on the one end of the magnetic separation flow path is opened to the magnetic separation flow path in a state that the electromagnet is excited, to introduce into the magnetic separation flow path, the sorting target fluid from the sorting target fluid introducing flow path and have the magnetically attractable substance magnetically attracted to the magnetic filter, and only the third on-off valve of the on-off valves on the other end of the magnetic separation flow path is opened to discharge into the non-magnetically attractable substance discharging flow path, the sorting target fluid from which the magnetically attractable substance has been magnetically attracted.

<Residual Non-Magnetically Attractable Substance Sorting Step>

The residual non-magnetically attractable substance sorting step is a step in which after the non-magnetically attractable substance sorting step, only the second on-off valve of the on-off valves on the one end of the magnetic separation flow path is opened to the magnetic separation flow path in a state that the electromagnet is excited, to introduce a first carrier fluid from a first carrier fluid introducing flow path, and only the third on-off valve of the on-off valves on the other end of the magnetic separation flow path is opened to have the first carrier fluid carry the sorting target fluid in a state that the magnetically attractable substance remaining in the magnetic separation flow path has been magnetically attracted to the magnetic filter, to discharge the sorting target fluid into the non-magnetically attractable substance discharging flow path from the magnetic separation flow path.

In the sorting method according to the present invention, after the operation of the non-magnetically attractable substance sorting step, the sorting target fluid retained in the magnetic separation flow path is carried by the first carrier fluid as the sorting target fluid from which the magnetically attractable substance has been magnetically attracted to the magnetic filter, to discharge the sorting target fluid to the outside of the magnetic separation flow path. This makes it possible to overcome the problem described with reference to FIG. 1B that upon switching the non-magnetically attractable substance sorting step to the magnetically attractable substance sorting step in the conventional sorting device, the non-sorted sorting target fluid and the like retained in the magnetic separation flow path is discharged to the magnetically attractable substance discharging flow path.

<Magnetically Attractable Substance Sorting Step>

The magnetically attractable substance sorting step is a step in which after the residual non-magnetically attractable substance sorting step, only the fourth on-off valve of the on-off valves on the other end of the magnetic separation flow path is opened to the magnetic separation flow path in a state that the electromagnet is released from excitation, to introduce the second carrier fluid from a second carrier fluid introducing flow path, and only the fifth on-off valve of the on-off valves on the one end of the magnetic separation flow path is opened to have the second carrier fluid carry the magnetically attractable substance detached from the magnetic filter to discharge the magnetically attractable substance into the magnetically attractable substance discharging flow path from the magnetic separation flow path.

The non-magnetically attractable substance sorting step, the residual non-magnetically attractable substance sorting step, and the magnetically attractable substance sorting step are not particularly limited but these steps are preferably performed as a series of steps. Specifically, it is preferable that after the magnetically attractable substance sorting step, the process be returned again to the non-magnetically attractable substance sorting step to perform the steps sequentially and successively. By operating the successive treatments in this cycle, it is possible to effectively sort the magnetically attractable substance and the non-magnetically attractable substance from the sorting target fluid. Switching from the non-magnetically attractable substance sorting step to the residual non-magnetically attractable substance sorting step can be performed through appropriate adjustment based on the magnetic attraction capability of the magnetic filter. Switching from the residual non-magnetically attractable substance sorting step to the magnetically attractable substance sorting step can be performed through appropriate adjustment of the timing when the non-sorted sorting target fluid and the like retained in the magnetic separation flow path after the operation of the non-magnetically attractable substance sorting step are completely discharged to the outside of the magnetic separation flow path.

<Residual Substance Discharging Step>

The residual substance discharging step is a step which is provided between the residual non-magnetically attractable substance sorting step and the magnetically attractable substance sorting step and in which only the second on-off valve of the on-off valves on the one end of the magnetic separation flow path is opened to the magnetic separation flow path in a state that the electromagnet is excited, to introduce the first carrier fluid from the first carrier fluid introducing flow path, and only the sixth on-off valve of the on-off valves on the other end of the magnetic separation flow path is opened to have the first carrier fluid carry a residual substance remaining in the magnetic filter, to discharge the residual substance into the residual substance discharging flow path from the magnetic separation flow path.

In the sorting method according to the present invention, the first carrier fluid is introduced independently of the second carrier fluid, which makes it possible to introduce the rinse liquid as the first carrier fluid into the magnetic separation flow path to wash away the residual substance remaining in the magnetic filter (e.g., the magnetically attractable substance and suspended particles contained in the sorting target fluid) from the magnetic filter and discharge the residual substance from the magnetic separation flow path.

When the non-magnetically attractable substance sorting step, the residual non-magnetically attractable substance sorting step, and the magnetically attractable substance sorting step are performed as a series of steps, the residual substance discharging step can also be performed as the series of steps. In this case, in the magnetically attractable substance sorting step operated after the residual substance discharging step, it is possible to recover a high purity of the magnetically attractable substance that is suppressed in inclusion of the residual substance, especially particles other than the magnetically attractable substance.

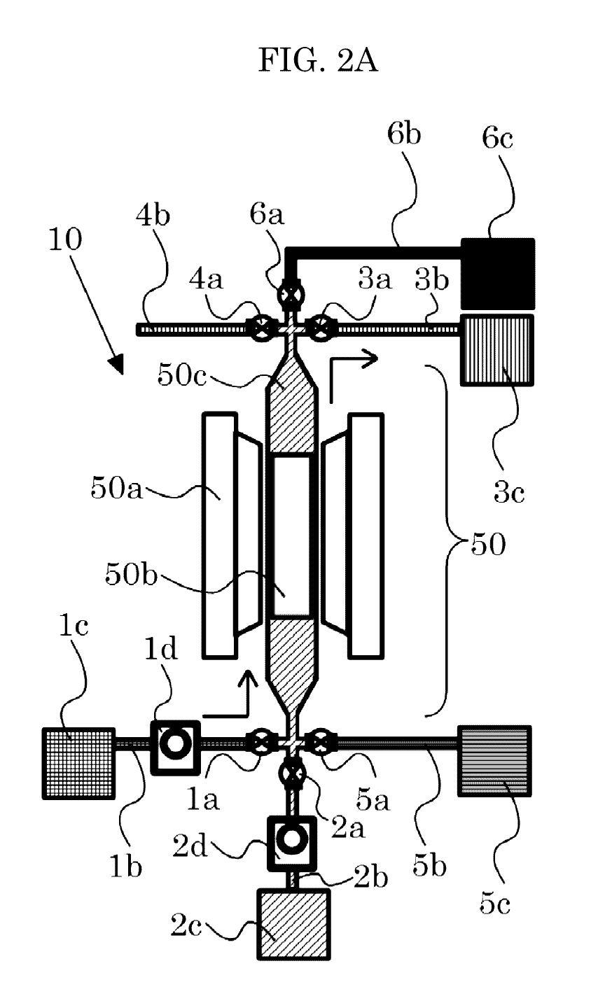

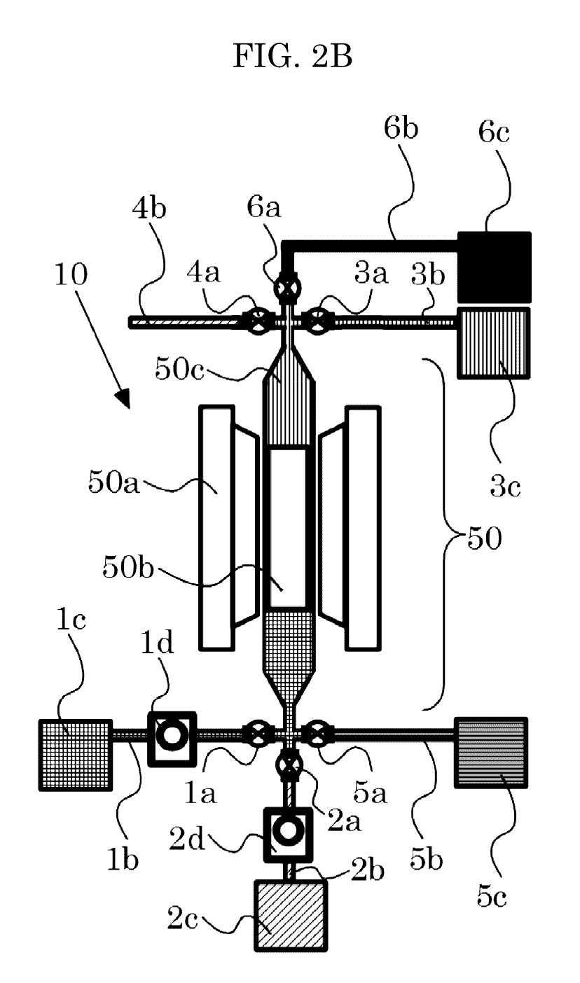

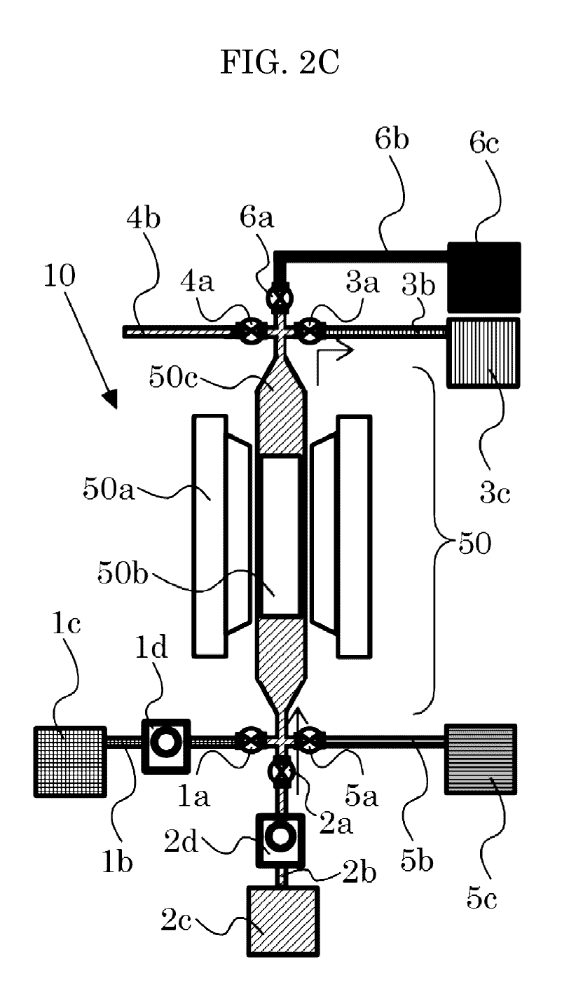

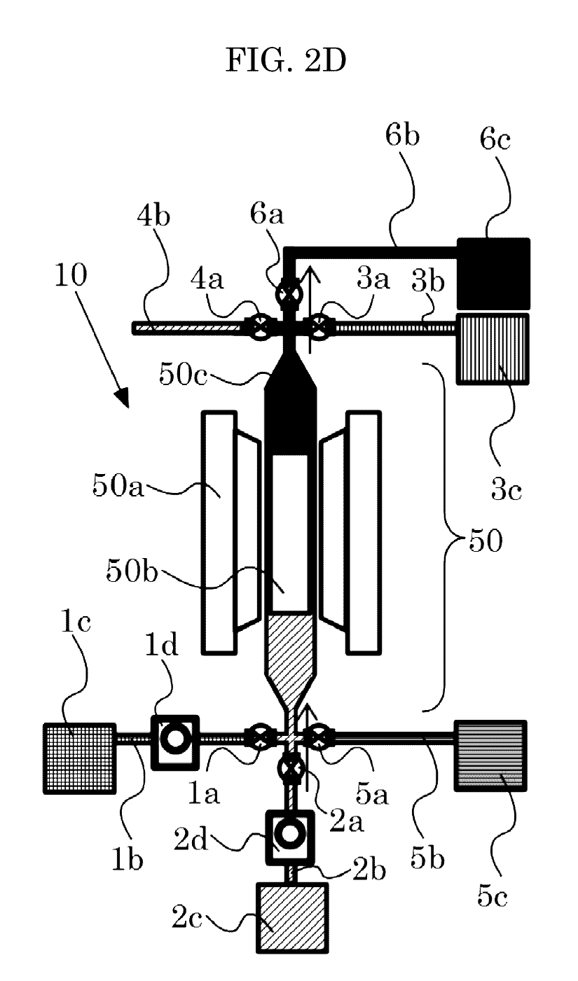

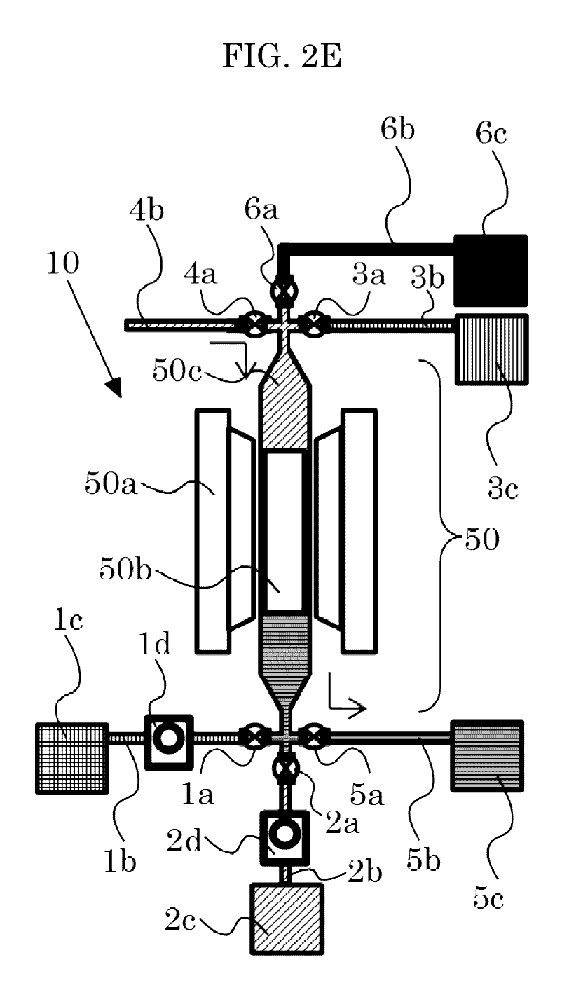

Embodiments of the sorting device and the sorting method according to the present invention described above will now be described in more detail with reference to FIGS. 2A to 2D. FIGS. 2A to 2D are each a depictive diagram depicting the sorting device according to one embodiment of the present invention.

As illustrated in FIG. 2A, a sorting device 10 includes as main members: a high gradient magnetic separating section 50 composed of an electromagnet 50a, a magnetic filter 50b, and a magnetic separation flow path 50c; a sorting target fluid introducing flow path 1b coupled to one end of the magnetic separation flow path 50c via a first on-off valve 1a and capable of introducing the sorting target fluid into the magnetic separation flow path 50c; a first carrier fluid introducing flow path 2b coupled to the one end of the magnetic separation flow path 50c via a second on-off valve 2a and capable of introducing the first carrier fluid (e.g., water) capable of carrying the sorting target fluid to the magnetic separation flow path 50c; a non-magnetically attractable substance discharging flow path 3b coupled to the other end of the magnetic separation flow path 50c via a third on-off valve 3a and capable of discharging from the magnetic separation flow path 50c, the sorting target fluid in a state that the magnetically attractable substance is magnetically attracted to the magnetic filter 50b; a carrier fluid introducing flow path 4b coupled to the other end of the magnetic separation flow path 50c via a fourth on-off valve 4a and capable of introducing into the magnetic separation flow path 50c, a second carrier fluid (e.g., water) capable of carrying the magnetically attractable substance detached from the magnetic filter 50b; a magnetically attractable substance discharging flow path 5b coupled to the one end of the magnetic separation flow path 50c via a fifth on-off valve 5a and capable of discharging from the magnetic separation flow path 50c, the carrier fluid that carries the magnetically attractable substance detached from the magnetic filter 50b; and a residual substance discharging flow path 6b coupled to the other end of the magnetic separation flow path 50c via a sixth on-off valve 6a and capable of discharging from the magnetic separation flow path 50c, the first carrier fluid (e.g., a rinse liquid) that carries the residual substance remaining in the magnetic filter 50b (e.g., the magnetically attractable substance and suspended particles contained in the sorting target fluid).

In this figure, 2-way valves are used as the first on-off valve 1a, the second on-off valve 2a, and the fifth on-off valve 5a disposed on the one end of the magnetic separation flow path 50c. However, these on-off valves may be integrated as a 3-way valve or 4-way valve. Similarly, 2-way valves are used as the third on-off valve 3a, the fourth on-off valve 4a, and the sixth on-off valve 6a disposed on the other end of the magnetic separation flow path 50c. However, these on-off valves may be integrated as a 3-way valve or 4-way valve.

The sorting device 10 uses the following sorting method to sort the magnetically attractable substance and the non-magnetically attractable substance by separating them from the sorting target fluid. Additionally, as an optional step, washing of the magnetic filter 50b is performed.

First, as illustrated by arrows in FIG. 2A, only the first on-off valve 1a of the on-off valves on the one end of the magnetic separation flow path 50c is opened to the magnetic separation flow path 50c in a state that the electromagnet 50a is excited, to introduce into the magnetic separation flow path 50c, the sorting target fluid introduced into the sorting target fluid introducing flow path 1b by means of a pump 1d from a storing section 1c storing the sorting target fluid and have the magnetically attractable substance magnetically attracted to the magnetic filter 50b, and only the third on-off valve 3a of the on-off valves on the other end of the magnetic separation flow path 50c is opened to discharge into the non-magnetically attractable substance discharging flow path 3b, the sorting target fluid from which the magnetically attractable substance has been magnetically attracted and recover the sorting target fluid into a non-magnetically attractable substance recovering section 3c (the non-magnetically attractable substance sorting step). The magnetic separation flow path 50c after the non-magnetically attractable substance sorting step retains, on the one end thereof, the non-sorted sorting target fluid not having undergone sorting by the magnetic filter 50b. Also, the magnetic separation flow path 50c retains, on the other end thereof, the sorting target fluid from which the magnetically attractable substance has been attracted and which is to be discharged into the non-magnetically attractable substance discharging flow path 3b (see FIG. 2B).

Next, as illustrated by arrows in FIG. 2C, after the non-magnetically attractable substance sorting step, only the second on-off valve 2a of the on-off valves on the one end of the magnetic separation flow path 50c is opened to the magnetic separation flow path 50c in a state that the electromagnet 50a is excited, to introduce from the first carrier fluid introducing flow path 2b, the first carrier fluid stored and the like in a storing second 2c, and only the third on-off valve 3a of the on-off valves on the other end of the magnetic separation flow path 50c is opened to have the first carrier fluid carry the non-sorted sorting target fluid and the like remaining in the magnetic separation flow path 50c, to discharge the non-sorted sorting target fluid and the like into the non-magnetically attractable substance discharging flow path 3b from the magnetic separation flow path 50c and recover the non-sorted sorting target fluid and the like into a non-magnetically attractable substance recovering section 3c (the residual non-magnetically attractable substance sorting step).

Next, as illustrated by arrows in FIG. 2D, only the second on-off valve 2a of the on-off valves on the one end of the magnetic separation flow path 50c is opened to the magnetic separation flow path 50c in a state that the electromagnet 50a is excited, to introduce the first carrier fluid (e.g., a rinse liquid) from the first carrier fluid introducing flow path 2b, and only the sixth on-off valve 6a of the on-off valves on the other end of the magnetic separation flow path 50c is opened to have the first carrier fluid carry the residual substance remaining in the magnetic filter 50b (e.g., the magnetically attractable substance and suspended particles contained in the sorting target fluid), to discharge the residual substance from the magnetic separation flow path 50c into a residual substance discharging flow path 6b and recover the residual substance into a residual substance recovering section 6c (the residual substance discharging step).

Next, as illustrated by arrows in FIG. 2E, only the fourth on-off valve 4a of the on-off valves on the other end of the magnetic separation flow path 50c is opened to the magnetic separation flow path 50c in a state that the electromagnet 50a is released from excitation, to introduce the second carrier fluid from the second carrier fluid introducing flow path 4b, and only the fifth on-off valve 5a of the on-off valves on the one end of the magnetic separation flow path 50c is opened to have the second carrier fluid carry the magnetically attractable substance detached from the magnetic filter 50c, to discharge the magnetically attractable substance from the magnetic separation flow path 50c into the magnetically attractable substance discharging flow path 5b and recover the magnetically attractable substance into a magnetically attractable substance recovering section 5c (the magnetically attractable substance sorting step).

In the sorting device 10, the first carrier fluid introducing flow path 2a is disposed and the residual non-magnetically attractable substance sorting step is performed, which makes it possible to, after non-magnetically attractable substance sorting step, have the first carrier fluid carry the non-sorted sorting target fluid and the like remaining in the magnetic separation flow path 50c, to discharge the non-sorted sorting target fluid and the like into the non-magnetically attractable substance discharging flow path 3b and recover into the non-magnetically attractable substance recovering section 3c, the sorting target fluid from which the magnetically attractable substance has been magnetically attracted to the magnetic filter 50b. In addition, the first carrier fluid introducing flow path 2a is disposed and the residual substance sorting step using the first carrier fluid (a rinse liquid) independent of the second carrier fluid is performed, which makes it possible to wash away the residual substance remaining in the magnetic filter 50b (e.g., the magnetically attractable substance and suspended particles contained in the sorting target fluid) from the magnetic filter 50b and suppress inclusion of the residual substance, especially particles other than the magnetically attractable substance, in the magnetically attractable substance recovering section 5c, to thereby recover a high purity of the magnetically attractable substance.

Therefore, it is possible to sort the magnetically attractable substance and the non-magnetically attractable substance from the sorting target fluid with high accuracy and high efficiency.

### REFERENCE SIGNS LIST

1a first on-off valve
1b sorting target fluid introducing flow path
1c storing section
1d pump
2a second on-off valve
2b first carrier fluid introducing flow path
2c storing section
3a third on-off valve
3b non-magnetically attractable substance discharging flow path
3c non-magnetically attractable substance recovering section
4a fourth on-off valve
4b second carrier fluid introducing flow path
5a fifth on-off valve
5b magnetically attractable substance discharging flow path
5c magnetically attractable substance recovering section
6a sixth on-off valve
6b residual substance discharging flow path
6c residual substance recovering section
10, 100 sorting device
50 high gradient magnetic separating section
50a electromagnet
50b magnetic filter
50c magnetic separation flow path
101a, 103a, 104a, 105a on-off valve
101b sorting target fluid introducing flow path
101c storing section
101d pump
103b non-magnetically attractable substance discharging flow path
103c non-magnetically attractable substance recovering section
104b carrier fluid introducing flow path
105b magnetically attractable substance discharging flow path
105c magnetically attractable substance recovering section

1. A sorting device, which is capable of sorting a magnetically attractable substance and a non-magnetically attractable substance by separating the magnetically attractable substance and the non-magnetically attractable substance from a sorting target fluid which is a mixture of the magnetically attractable substance and the non-magnetically attractable substance, the sorting device comprising:
a high gradient magnetic separating section, which includes an electromagnet, a magnetic filter capable of attracting or detaching the magnetically attractable substance with a magnetic field generated by the electromagnet, and a magnetic separation flow path with the electromagnet disposed outside and the magnetic filter disposed inside;
a sorting target fluid introducing flow path, which is coupled to one end of the magnetic separation flow path via a first on-off valve and is capable of introducing the sorting target fluid into the magnetic separation flow path;
a first carrier fluid introducing flow path, which is coupled to the one end of the magnetic separation flow path via a second on-off valve and is capable of introducing into the magnetic separation flow path, a first carrier fluid capable of carrying the sorting target fluid;
a non-magnetically attractable substance discharging flow path, which is coupled to other end of the magnetic separation flow path via a third on-off valve and is capable of discharging from the magnetic separation flow path, the sorting target fluid from which the magnetically attractable substance has been magnetically attracted to the magnetic filter, and the first carrier fluid;
a second carrier fluid introducing flow path, which is coupled to the other end of the magnetic separation flow path via a fourth on-off valve and is capable of introducing into the magnetic separation flow path, a second carrier fluid capable of carrying the magnetically attractable substance detached from the magnetic filter; and
a magnetically attractable substance discharging flow path, which is coupled to the one end of the magnetic separation flow path via a fifth on-off valve and is capable of discharging from the magnetic separation flow path, the second carrier fluid that carries the magnetically attractable substance detached from the magnetic filter.

2. The sorting device according to claim 1, further comprising a residual substance discharging flow path, which is coupled to the other end of the magnetic separation flow path via a sixth on-off valve and is capable of discharging from the magnetic separation flow path, the first carrier fluid that carries a residual substance remaining in the magnetic filter.

3. A sorting method for sorting a magnetically attractable substance and a non-magnetically attractable substance by separating the magnetically attractable substance and the non-magnetically attractable substance with a sorting device which is capable of sorting a magnetically attractable substance and a non-magnetically attractable substance by separating the magnetically attractable substance and the non-magnetically attractable substance from a sorting target fluid which is a mixture of the magnetically attractable substance and the non-magnetically attractable substance, where the sorting device includes: a high gradient magnetic separating section, which includes an electromagnet, a magnetic filter capable of attracting or detaching the magnetically attractable substance with a magnetic field generated by the electromagnet, and a magnetic separation flow path with the electromagnet disposed outside and the magnetic filter disposed inside; a sorting target fluid introducing flow path, which is coupled to one end of the magnetic separation flow path via a first on-off valve and is capable of introducing the sorting target fluid into the magnetic separation flow path; a first carrier fluid introducing flow path, which is coupled to the one end of the magnetic separation flow path via a second on-off valve and is capable of introducing into the magnetic separation flow path, a first carrier fluid capable of carrying the sorting target fluid; a non-magnetically attractable substance discharging flow path, which is coupled to other end of the magnetic separation flow path via a third on-off valve and is capable of discharging from the magnetic separation flow path, the sorting target fluid from which the magnetically attractable substance has been magnetically attracted to the magnetic filter, and the first carrier fluid; a second carrier fluid introducing flow path, which is coupled to the other end of the magnetic separation flow path via a fourth on-off valve and is capable of introducing into the magnetic separation flow path, a second carrier fluid capable of carrying the magnetically attractable substance detached from the magnetic filter; and a magnetically attractable substance discharging flow path, which is coupled to the one end of the magnetic separation flow path via a fifth on-off valve and is capable of discharging from the magnetic separation flow path, the second carrier fluid that carries the magnetically attractable substance detached from the magnetic filter, the sorting method comprising:
a non-magnetically attractable substance sorting step in which only the first on-off valve of the on-off valves on the one end of the magnetic separation flow path is opened to the magnetic separation flow path in a state that the electromagnet is excited, to introduce the sorting target fluid from the sorting target fluid introducing flow path and have the magnetically attractable substance magnetically attracted to the magnetic filter, and only the third on-off valve of the on-off valves on the other end of the magnetic separation flow path is opened to discharge into the non-magnetically attractable substance discharging flow path, the sorting target fluid in a state that the magnetically attractable substance is magnetically attracted;
a residual non-magnetically attractable substance sorting step in which after the non-magnetically attractable substance sorting step, only the second on-off valve of the on-off valves on the one end of the magnetic separation flow path is opened to the magnetic separation flow path in a state that the electromagnet is excited, to introduce a first carrier fluid from a first carrier fluid introducing flow path, and only the third on-off valve of the on-off valves on the other end of the magnetic separation flow path is opened to have the first carrier fluid carry the sorting target fluid in a state that the magnetically attractable substance remaining in the magnetic separation flow path has been magnetically attracted to the magnetic filter, to discharge the sorting target fluid into the non-magnetically attractable substance discharging flow path from the magnetic separation flow path; and
a magnetically attractable substance sorting step in which after the residual non-magnetically attractable substance sorting step, only the fourth on-off valve of the on-off valves on the other end of the magnetic separation flow path is opened to the magnetic separation flow path in a state that the electromagnet is released from excitation, to introduce the second carrier fluid from a second carrier fluid introducing flow path, and only the fifth on-off valve of the on-off valves on the one end of the magnetic separation flow path is opened to have the second carrier fluid carry the magnetically attractable substance detached from the magnetic filter to discharge the magnetically attractable substance into the magnetically attractable substance discharging flow path from the magnetic separation flow path.

4. The sorting method according to claim 3,
wherein the non-magnetically attractable substance sorting step, the residual non-magnetically attractable substance sorting step, and the magnetically attractable substance sorting step are repeatedly performed as a series of steps.

5. The sorting method according to claim 3, further comprising a residual substance discharging step, which is provided between the residual non-magnetically attractable substance sorting step and the magnetically attractable substance sorting step and in which only the second on-off valve of the on-off valves on the one end of the magnetic separation flow path is opened to the magnetic separation flow path in a state that the electromagnet is excited, to introduce the first carrier fluid from the first carrier fluid introducing flow path, and only the sixth on-off valve of the on-off valves on the other end of the magnetic separation flow path is opened to have the first carrier fluid carry a residual substance remaining in the magnetic filter, to discharge the residual substance into the residual substance discharging flow path from the magnetic separation flow path.

6. The sorting method according to claim 4, further comprising a residual substance discharging step, which is provided between the residual non-magnetically attractable substance sorting step and the magnetically attractable substance sorting step and in which only the second on-off valve of the on-off valves on the one end of the magnetic separation flow path is opened to the magnetic separation flow path in a state that the electromagnet is excited, to introduce the first carrier fluid from the first carrier fluid introducing flow path, and only the sixth on-off valve of the on-off valves on the other end of the magnetic separation flow path is opened to have the first carrier fluid carry a residual substance remaining in the magnetic filter, to discharge the residual substance into the residual substance discharging flow path from the magnetic separation flow path.
